(19) United States
(12) Patent Application Publication
(10) Pub. No.: US 2023/0194755 A1
(43) Pub. Date: Jun. 22, 2023

(54) DATA-DRIVEN RAPID TRACEABILITY METHOD FOR AIR POLLUTANTS IN SMALL-SCALE REGIONALS

(71) Applicants: ZHEJIANG UNIVERSITY OF TECHNOLOGY, Hangzhou (CN); ZHEJIANG UNIVERSITY, Hangzhou City (CN)

(72) Inventors: Jianmeng Chen, Hangzhou (CN); Qiaoli Wang, Hangzhou (CN); Wei Li, Hangzhou (CN); Sujing Li, Hangzhou (CN); Zhuowei CHENG, Hangzhou (CN)

(21) Appl. No.: 18/082,214

(22) Filed: Dec. 15, 2022

(30) Foreign Application Priority Data
Dec. 16, 2021 (CN) 202111534936.9

(51) Int. Cl. G01W 1/10; G06N 3/08

(52) U.S. Cl. CPC G01W 1/10; G06N 3/08

(57) ABSTRACT

The present invention relates to a data-driven rapid traceability method for air pollution in small-scale regions, comprising: localizing the land use type information of air pollution diffusion model and simulating the meteorological field; according to local meteorological conditions, constructing the meteorological scenarios with the combination of equidistantly divided meteorological parameters; forming the pollution traceability database by the traceability results which is obtained by stimulating the meteorological scenarios via the air pollution diffusion simulation platform; building the data-driven model by taking the pollution traceability database as training data for fitting; realizing the rapid pollution traceability by matching the pollution traceability database or triggering the data-driven model by the real-time meteorological conditions. The present invention greatly improves the precision and speed of pollution traceability, realizes significant improvement in the comprehensive control of air pollution in small-scale regions, greatly supports the substantial reduction of VOCs to effectively improve the air quality.

### TECHNICAL FIELD

The present invention relates to the field of air pollution prevention and control, in particular to a method for rapidly tracing air pollution.

### BACKGROUND ART

The density of enterprises in industrial park is high, and pollution emissions are concentrated, especially, VOCs emissions are characterized by multiple sources, multiple species, and uneven distribution of time and space, which make VOCs and other pollutions in the park difficult to monitor, and make the pollution characteristics and pollution sources unclear, so that, pollution incidents occur from time to time, the emergency response to pollution incidents is slow, which is causing significant harm to the ecological environment and health problem in the park and the surrounding areas. Carrying out rapid traceability of air pollution on a small-scale in industrial parks is an important way to identify pollution source, which is crucial to the scientific control of pollution in the park, and provide an important support for effectively guaranteeing the quality of the atmospheric environment.

At present, the source emission inventory method, the receptor oriented model method, and the source model method are mostly used to retrace the source of air pollution in small-scale regions. The source emission inventory method only considers pollution source emissions and ignores the diffusion and transformation of pollutions in the atmosphere. The receptor oriented model such as CMB and PMF and their improvements have certain limitations because of the dependence of high monitoring requirements for pollution components. The AERMOD diffusion model is a steady-state smoke plume model established by using the Gaussian diffusion formula, which is based on the atmospheric boundary layer and atmospheric diffusion theory and on the premise of assuming the concentration of pollution conforms to a normal distribution within a certain range, wherein the AERMOD diffusion model is a small-scale air diffusion model recommended by the Technical Guidelines for Environmental Impact Assessment-Atmospheric Environment (HJ2.2-2018), however, the simulation process of the AERMOD diffusion model is time-consuming and effectiveness in traceability of pollution incidents is insufficient. Currently, as the higher requirements in regional control have been raised, higher requirements are also put forward for the precision, accuracy and speed of pollution simulation. The simulation process of the existing diffusion models (such as AERMOD, etc.) to retrace pollutions diffusion is time-consuming, so that it is difficult to rapidly identify the main pollution sources and source contributions when a pollution incident occurs, which makes the emergency response to the pollution incident relatively lagged, therefore, the efficient, intelligent and scientific control cannot be met.

### SUMMARY OF THE INVENTION

The present invention aims to solve the problem that the simulation of real-time traceability to pollution incident is time-consuming in the prior art, and provides a data-driven rapid traceability method for air pollution in small-scale regions. The present invention establishes meteorological scenarios based on equidistant changes of meteorological parameters, carries out traceability simulations of a large number of meteorological scenarios in combination with regional pollution emissions inventories, and then establishes a one-to-one correspondence data set between meteorological scenarios and traceability results, and uses them as samples of machine learning for machine learning fitting, building an artificial neural network machine learning model driven by meteorological parameters, so as to realize fast and accurate traceability in small-scale regions, greatly improving the timeliness and precision of pollution traceability.

A data-driven rapid traceability method for air pollution in small-scale regions, comprising the following steps:

S1, Localizing the air pollution diffusion model and building a simulation framework of the model. Setting relevant parameters and data sets such as ground data, high-altitude data, and land use types of the model to localize the model. Setting the source emission characterization and receptor points according to the actual emission information of the region and ascertaining the simulation framework of the model.

S2, Constructing the meteorological scenarios. Clarifying the local conventional meteorological statistical parameters according to the regional historical meteorological monitoring data, and ascertaining the range of local meteorological parameters. Dividing meteorological elements, such as temperature, wind direction, wind speed, low cloud cover, total cloud cover and other meteorological elements as equal intervals, wherein the range of wind direction can be set to 0° ˜315° (the true north direction is 0°), the range of total cloud cover can be set to 0˜10%, the range of low cloud cover can be set to 0 ˜10%, adjusting the range according to the actual meteorological conditions, adjusting the intervals according to the requirements of accuracy. Constructing different meteorological scenarios by permutation and combination, and a combination of a set of meteorological parameters is a sample of a meteorological scenario.

S3, Simulating the traceability of meteorological scenarios. Analyzing the contribution of each pollution source to the receptor pollution concentration in each meteorological scenario by combining the regional pollution source emission list, and the meteorological scenarios constructed above, and the determined simulation framework of the air pollution diffusion model; Making the summary list by using the contribution proportion of each source category to the receptor concentration as the traceability result.

S4. Establishing a pollution traceability database. Integrating meteorological scenarios and corresponding traceability results, forming a pollution traceability sample by the data pair constituted by a meteorological scenario and its corresponding traceability results, and assembling the pollution traceability samples to establish a pollution traceability database.

S5, Training the data-driven model; Taking the pollution traceability database as a data set, taking the meteorological conditions of the pollution traceability database as inputs, and taking the contribution proportions of pollution sources as outputs, and regarding each pollution traceability sample as a training sample, and forming the data-driven model driven by meteorological parameters based on artificial neural network function training which is implemented by the “trainbr” algorithm of the MATLAB artificial neural network, and the internal parameters of the model are adjusted and optimized to finally build the optimal data-driven model.

S6, Retracing the pollution source; Under real-time meteorological conditions, matching the meteorological parameters by searching the pollution tracing database using meteorological parameters as keywords; If the matching is successful, the real-time contribution proportion of each source category to the concentration of the receptor pollutions is captured; if not matched, the data-driven model trained by the above artificial neural network is used to build a real-time meteorological scenario-driven model with real-time meteorological parameters to capture the concentration contribution of each pollution source category to the receptor, that is, to obtain the real-time contribution proportion of each source category, so as to realize rapid and accurate pollution source tracing; Ranking the obtained real-time pollution contribution proportion of each source category to the receptor, and capturing the pollution source category with dominant contribution to receptor pollution, to support the scientific and effective control of regional air pollution.

Preferably, the air pollution diffusion model described in S1 is selected from commonly used air pollution diffusion models such as AERMOD and CALPUFF, which are suitable for the simulation of small and medium-scale pollution diffusion.

Preferably, the local conventional meteorological statistical parameters described in S2, the ranges of wind speed and temperature are determined according to local meteorological historical data, and the range of wind direction includes the whole range with intervals adjusted according to the accuracy requirements.

Preferably, the pollution traceability database described in S4 is compiled from the data pairs formed by one-to-one correspondence between each meteorological scenario and its corresponding traceability results; one data pair is one pollution traceability sample, and each data pair is compiled in a fixed parameters order generally ranked as serial number, wind direction, wind speed, temperature, total cloud cover, low cloud cover, and the source contribution coded in order.

Preferably, the data-driven model described in S5 is trained by artificial neural network functions to form a model driven by meteorological parameters which is implemented by the MATLAB artificial neural network “trainbr” algorithm, that is, the Bayesian Regularization algorithm is used to find a function that can effectively approximate the sample set and minimizes the error function, and the mean square error function ED is used to train the error function:

$${E}_{D} = \frac{1}{N} {\sum }_{i = 1}^{N} {( {e}_{i} )}^{2} = \frac{1}{N} {\sum }_{i = 1}^{N} {( {t}_{i} - {a}_{i} )}^{2} \qquad ( 1 )$$

Wherein N is the number of samples, tᵢ is the expected output value, and aᵢ is the actual output value of the network.

The mean values of the sum of square of network weights added to the objective function to improve the generalization ability, and the improved error function becomes:

E=ξ1·E_{D}+ξ₂·E_{W} ξ₂)

In the formula,

$${E}_{W} = \frac{1}{N} {Σ}_{j = 1}^{N} {( {W}_{j} )}^{2} ,$$

Wⱼ is the connection weight of the network, j is the number of network connection weights; ξ₁ and ξ₂ are parameters, if ξ₁ is much larger than (2, the training algorithm makes the network error smaller, and adaptively adjusts the parameters in the training process to achieve the optimum.

Preferably, the real-time meteorological parameters are current meteorological monitoring data or meteorological monitoring data within a prescribed period.

Preferably, the real-time meteorological parameters described in S6 at least comprise wind direction, wind speed, and temperature.

The present invention comprise the following advantages: building a pollution traceability system by integrating the air pollution diffusion model and machine learning method around the small-scale area, and innovatively proposing a technical method for rapid traceability to pollution source when pollution occurs, having the characteristics of rapid traceability speed and high accuracy, which effectively supporting the substantial reduction of VOCs and other pollutions in small-scale regions and effectively improving the air quality of region, so that, achieving a significant improvement of the comprehensive air pollution control capabilities of the park.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 Flow chart of the technical solution of the present invention

FIG. 2 Schematic diagram of the statistics results of the land use types parameters of the example AERMOD model

FIG. 3 Schematic diagram of the meteorological field built by the example WRF

FIG. 4 Display diagram of the pollution traceability database of the example

FIG. 5 Schematic diagram of the pollution source traceability result of the example

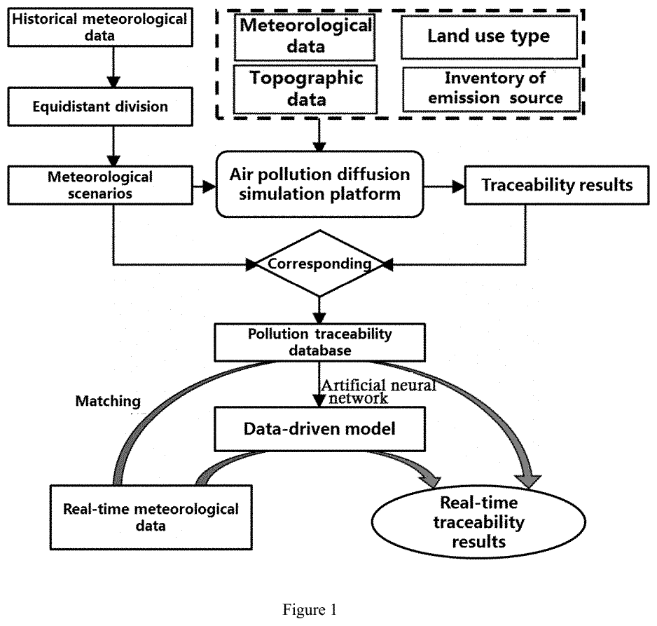

### SPECIFIC EMBODIMENT

The technical solution of the present invention will be further described below in conjunction with the drawings.

This embodiment uses a data-driven method for rapid traceability of air pollutions in small-scale regions, and the specific steps are as follows:

### 1. Localizing the AERMOD Models

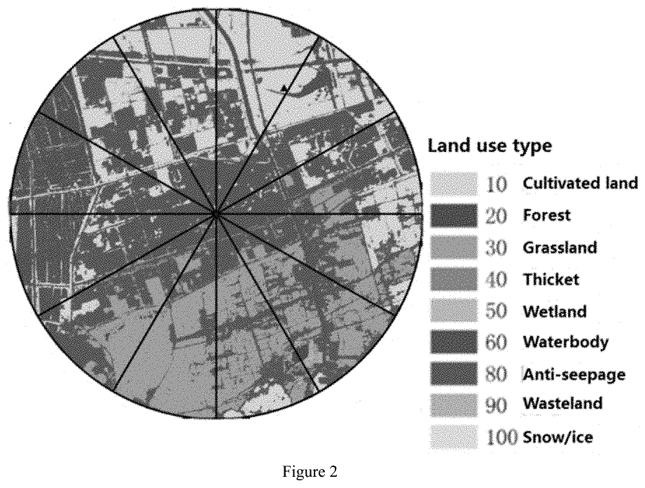

To build a simulation platform, firstly, ascertaining the land use types information in the simulation regions. In the land use parameters of the AERMOD model, taking the center point of the study regions as the center of a circular, the circular area with a radius of 1 km is divided into 12 circular sectors, calculating the roughness of circular sector based on the proportion of the different land use type area, calculating the albedo and Bowen rate based on a 3 km×3 km rectangular area centered on the center point of the study regions. The information of land use types are taken from the FROM-GLC10-2017v01 data set (10 m resolution), the calculation results of the final land use types parameters are shown in FIG. 2.

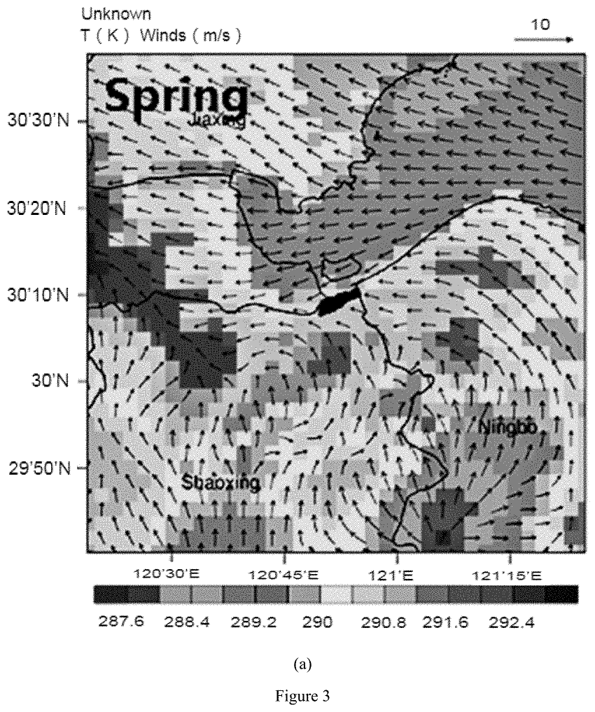

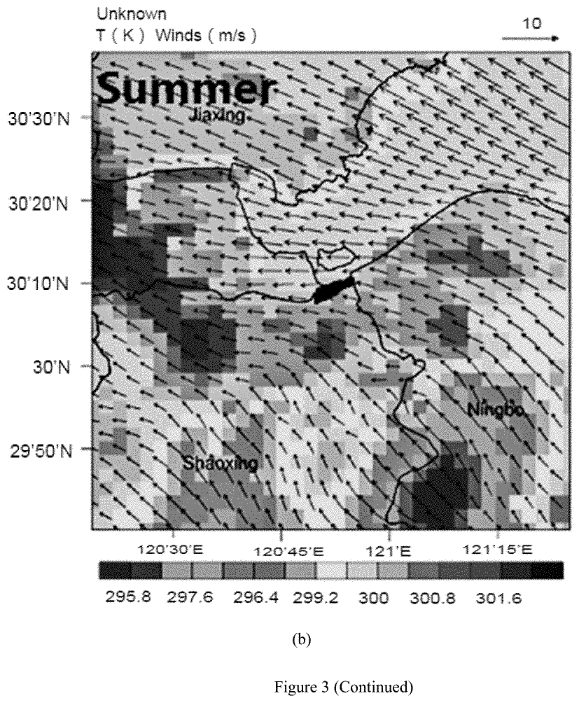

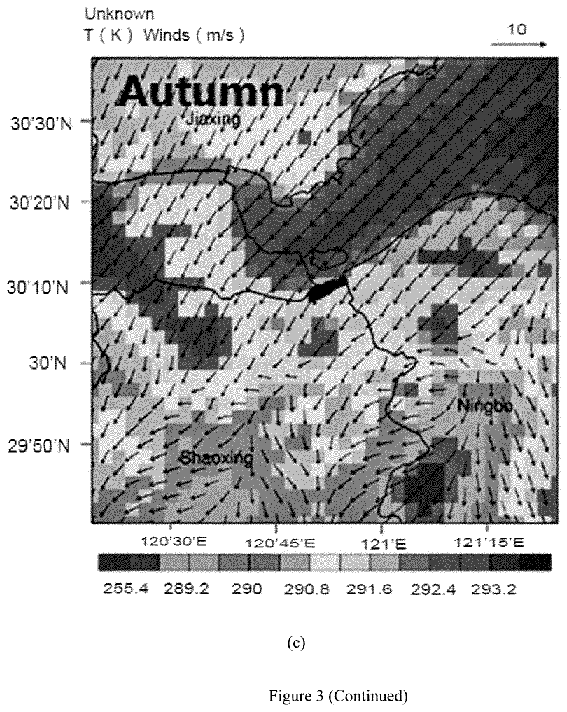

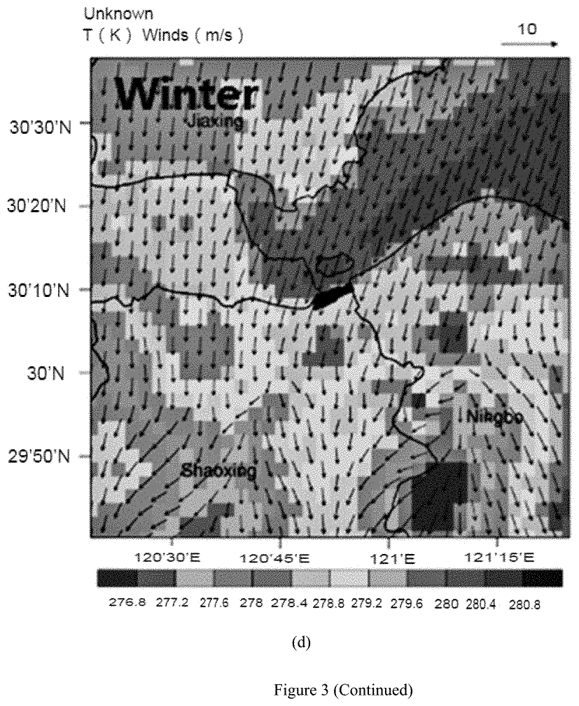

Stimulating the local meteorological field by the WRF model, applying four-layer grid nesting which the grid spacing of the innermost grid is accurate to 1 km, the outer layer provides boundary conditions for the inner layer to improve the accuracy of the simulation of inner layer. The first layer is 1620×1458 km with a resolution of 27 km; the second layer is 513×405 km with a resolution of 9 km; the third layer is 108×108 km with a resolution of 3 km; the fourth layer covers the industrial park with a range of 24×24 km and a resolution of 1 km. Generating a three-dimensional meteorological field by the WRF-ARW mesoscale meteorological model; the results are shown in FIG. 3.

### 2. Constructing the Pollution Traceability Database

In order to predict the diffusion concentration of pollution sources in various meteorological conditions, dividing meteorological elements such as temperature, wind direction, wind speed, low cloud cover, total cloud cover and the like, into equal intervals, obtaining different meteorological scenarios by the permutation and combination of meteorological elements. Ascertaining the setting range of meteorological scenarios according to the statistical analysis of local meteorological historical data, the specific division scheme is as follows:

Generating all possible meteorological conditions by the permutation and combination of seven meteorological elements such as wind direction, wind speed, temperature, total cloud cover and low cloud cover, wherein the range of wind direction is setting to 0°˜3150 (the true north direction is 0°, and the interval is 45°), the range of wind speed is setting to 1˜13 m/s (the interval is 2 m/s), the range of temperature is setting to −5˜45° C. (the interval is 5° C.), the range of total cloud cover is setting to 0˜10 (the interval is 2), and the range of low cloud cover is setting to 0˜10 (the interval is 2). The numbers of pollution sources and receptors are 86 and 32 in the simulation process of the model.

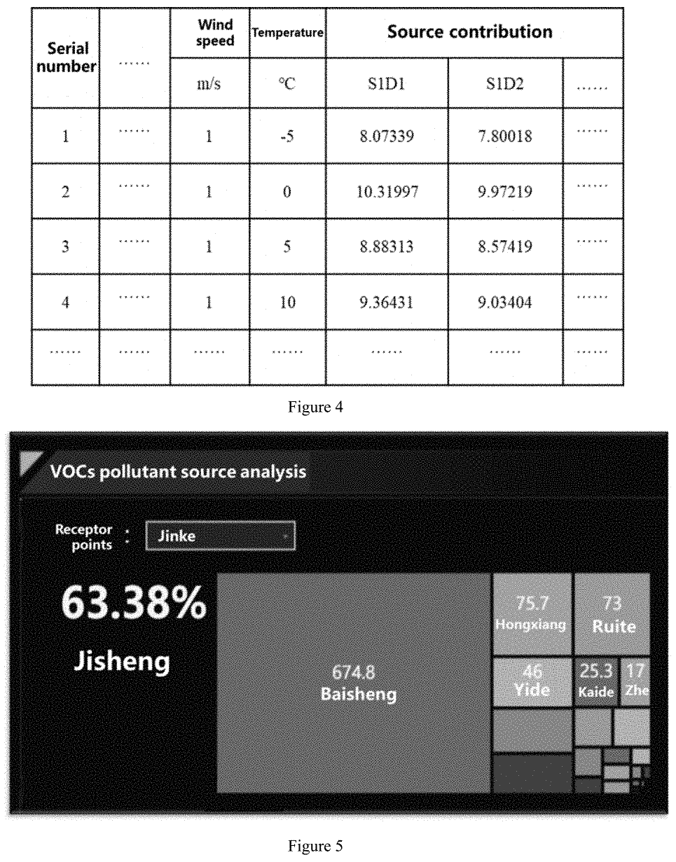

Based on the land use types information and the meteorological field established above, obtaining the concentration contribution of each pollution source to the receptor in each meteorological scenario is by simulation of the AERMOD diffusion model. Making the summary list by using the contribution proportion of each source category to the receptor concentration as the traceability result, establishing pollution traceability database by the pollution traceability samples which is assembled by the meteorological scenarios and the corresponding traceability results. Encoding emission source in order of S₁, S₂, . . . , Sₙ, encoding the environmental receptors in order of D₁, D₂, . . . , Dₘ, forming the contribution of each source category to each environmental receptor S₁D₁, S₂D₂, . . . , SₙDₘ by the further permutation and combination of emission source and environmental receptor. Part of the content of the pollution traceability database is shown in FIG. 4.

### 3. Building a Data-Driven Model

Although the pollution scenarios contained in the pollution traceability database constructed above are numerous, they still cannot cover all the scenarios of all meteorological conditions in practical applications. Based on the data pair constituted by meteorological scenarios and traceability results, taking the meteorological conditions and the pollution concentration of receptor in the pollution traceability database as inputs, taking the concentration contribution of pollution sources to receptors as outputs, forming a continuous data-driven model by training the limited data in the pollution traceability database with artificial neural networks algorithm of MATLAB software.

Taking the data pair constituted by each meteorological parameter and corresponding traceability result as the training sample of the artificial neural network, performing the training process by the “trainbr” algorithm of MATLAB software, in which taking the meteorological parameters as input layer, taking the concentration contribution of emission sources to each receptor point as output layer, setting the number of neurons in the hidden layer to 8, and setting the proportions of the training set, validation set, and test set to 0.7, 0.15, and 0.15, respectively. Returning to the trained net network after executing the training script, calculating the simulated value of the pollution concentration in various meteorological parameters by the net network, calculating fitting effect R² value equal to 0.947 by the combination of above stimulated value and the output data in the source file, indicating that the built net network has good performance on simulation.

### 4. Application Example of Real-Time Pollution Traceability System

Forming a real-time and accurate pollution traceability system at small-scale in the park by integrating pollution traceability database and the data-driven model, the example of pollution traceability process is as follows:

Based on the trained net network, matching the real-time meteorological parameters with meteorological scenarios in the pollution traceability database by taking real-time meteorological parameters as keywords for searching, the meteorological scenario of the present application example constituted by wind direction of 15°, wind speed of 5.2 m/s, temperature of 21.5° C., total cloud cover of 7, and low cloud cover of 4, obviously, this meteorological condition is not contained in the meteorological scenarios of the pollution traceability database. Therefore, constructing a new meteorological scenario (15, 5.2, 21.5, 7, 4) with wind direction of 15°, temperature of 21.5° C., wind speed of 5.2 m/s, total cloud cover of 7, and low cloud cover of 4, taking the new meteorological scenario as input, executing the data-driven model, calculating the pollution concentration of 86 pollution sources to 32 receptor points, obtaining the contribution rate r of each pollution source category to receptor point A based on the concentration proportion.

$${r}_{i , j} = \frac{{C}_{i , j}}{{Σ}_{n = 1}^{N} {C}_{n , j}}$$

Wherein, r_{i,j} is the contribution rate of the i source to the pollution concentration of the j receptor point, C_{i,j} is the pollution concentration of the i source to the j receptor point, and n is serial number of the emission source, total N=86 in the present example. Ranking with the descending order of r_{i,j}, the source category corresponding to the maximum value of r_{i,j} is the source category which contributes most to the receptor point, C_{i,j} is the corresponding contribution concentration, r_{i,j} is the corresponding contribution rate. The traceability result of present example is shown in FIG. 5.

1. A data-driven rapid traceability method for air pollution in small-scale regions, comprises:
S1, localizing the air pollution diffusion model and building a simulation framework of the model; Setting relevant parameters and data sets such as ground data, high-altitude data, and land use types of the model to localize the model; setting the source emission characterization and receptor points according to the actual emission information of the region and ascertaining the simulation framework of the model;
S2, constructing the meteorological scenarios; classifying the local conventional meteorological statistical parameters according to the regional historical meteorological monitoring data, and ascertaining the range of local meteorological parameters; dividing meteorological elements, such as temperature, wind direction, wind speed, low cloud cover, total cloud cover and other meteorological elements at equal intervals; constructing different meteorological scenarios by permutation and combination, and a combination of a set of meteorological parameters is a sample of a meteorological scenario;
S3, simulating the traceability of meteorological scenarios; analyzing the contribution of each pollution source to the receptor pollution concentration in each meteorological scenario by combining the regional pollution source emission list, and the meteorological scenarios constructed above, and the determined simulation framework of the air pollution diffusion model; making the summary list by using the contribution proportion of each source category to the receptor concentration as the traceability result;
S4. establishing a pollution traceability database; integrating meteorological scenarios and corresponding traceability results, forming a pollution traceability sample by the data pair constituted by a meteorological scenario and its corresponding traceability results, and assembling the pollution traceability samples to establish a pollution traceability database.
S5, training the data-driven model; taking the pollution traceability database as a data set, taking the meteorological conditions of the pollution traceability database as inputs, and taking the contribution proportions of pollution sources as outputs, and regarding each pollution traceability sample as a training sample, and forming the data-driven model driven by meteorological parameters based on artificial neural network function training which is implemented by the “trainbr” algorithm of the MATLAB artificial neural network, and the internal parameters of the model are adjusted and optimized to finally build the optimal data-driven model.
S6, retracting the pollution source; under real-time meteorological conditions, matching the meteorological parameters by searching the pollution tracing database using meteorological parameters as keywords; if the matching is successful, the real-time contribution proportion of each source category to the concentration of the receptor pollution is captured; if not matched, the data-driven model trained by the above artificial neural network is used to build a real-time meteorological scenario-driven model with real-time meteorological parameters to capture the concentration contribution of each pollution source category to the receptor, that is, to obtain the real-time contribution proportion of each source category, so as to realize rapid and accurate pollution source tracing; ranking the obtained real-time pollution contribution proportion of each source category to the receptor, and capturing the pollution source category with dominant contribution to receptor pollution, to support the scientific and effective control of regional air pollution.

2. The method for according to claim 1, wherein the air pollution diffusion model described in S1 is selected from commonly used air pollution diffusion models such as AERMOD and CALPUFF, which are suitable for the simulation of small and medium-scale pollution diffusion.

3. The method according to claim 1, wherein the local conventional meteorological statistical parameters described in S2, the ranges of wind speed and temperature are determined according to local meteorological historical data, and the range of wind direction includes the whole range with intervals adjusted according to the accuracy requirements.

4. The method according to claim 1, wherein the pollution traceability database described in S4 is compiled from the data pairs formed by one-to-one correspondence between each meteorological scenario and its corresponding traceability results; one data pair is one pollution traceability sample, and each data pair is assembled in a fixed parameters order generally ranked as serial number, wind direction, wind speed, temperature, total cloud cover, low cloud cover, and coding the source contribution in order.

5. The method according to claim 1, wherein the data-driven model described in S5 is trained by artificial neural network functions to form a model driven by meteorological parameters which is implemented by the MATLAB artificial neural network “trainbr” algorithm, that is, the Bayesian Regularization algorithm is used to find a function that can effectively approximate the sample set and minimizes the error function, and the mean square error function ED is used to train the error function:
$${E}_{D} = \frac{1}{N} {\sum }_{i = 1}^{N} {( {e}_{i} )}^{2} = \frac{1}{N} {\sum }_{i = 1}^{N} {( {t}_{i} - {a}_{i} )}^{2} \qquad ( 1 )$$
wherein N is the number of samples, tᵢ is the expected output value, and aᵢ is the actual output value of the network;
the mean of the sum of square of network weights are added to the objective function to improve the generalization ability, and the improved error function becomes:
E=ξ₁·E_{D}+ξ₂·E_{W} (2)
in the formula,
$${E}_{W} = \frac{1}{N} {Σ}_{j = 1}^{N} {( {W}_{j} )}^{2} ,$$
Wⱼ is the connection weight of the network, j is the number of network connection weights; ξ₁ and ξ₂ are parameters, if ξ₁ is much larger than ξ₂, the training algorithm makes the network error smaller, and adaptively adjusts the parameters in the training process to achieve the optimum.

6. The method according to claim 1, wherein the real-time meteorological parameters are current meteorological monitoring data or meteorological monitoring data within a prescribed period.

7. The method according to claim 1, wherein the real-time meteorological parameters described in S6 at least include wind direction, wind speed, and temperature.
